(19) United States
(12) Patent Application Publication
(10) Pub. No.: US 2025/0200561 A1
(43) Pub. Date: Jun. 19, 2025

(54) INTEROPERABLE VALUE EXCHANGE SYSTEM AND METHOD

(71) Applicant: Visa International Service Association, San Francisco, CA (US)

(72) Inventors: Joshua Quiroz, Vallejo, CA (US); Jeremy Philip George Horne, London (GB); Manoj V. Marathe, San Francisco, CA (US); Shipra Jha, Fremont, CA (US); Libby A. Kurien, San Francisco, CA (US); Vanitchand Virchand Shah, Edgeware (GB); Deepa Manjunath Nayak, Reading (GB)

(73) Assignee: Visa International Service Association, San Francisco, CA (US)

(21) Appl. No.: 18/980,729

(22) Filed: Dec. 13, 2024

Related U.S. Application Data
(60) Provisional application No. 63/609,682, filed on Dec. 13, 2023.
(60) Provisional application No. 63/700,589, filed on Sep. 27, 2024.

(51) Int. Cl. G06Q 20/38; G06Q 20/40

(52) U.S. Cl. CPC G06Q 20/381; G06Q 20/40

(57) ABSTRACT

A method includes receiving, from an exchange rate computer, a rate for exchange between a first value type and a second value type, providing, to a clearing and settlement system, the rate or a derivative thereof, and receiving a trade sum from the clearing and settlement system. The trade sum corresponds to an expected settlement amount for a plurality of transactions in which receivers in the transactions receive values of the second value type. At least some of the transactions utilize the rate or a derivative thereof. The method also includes transmitting, to a correspondent entity computer, an exchange request to exchange an amount of value from the first value type to the second value type. The amount of value is based on the trade sum. The clearing and settlement system initiates a transfer message to the correspondent entity computer to transfer the value of the second value type.

### CROSS-REFERENCES TO RELATED APPLICATIONS

This application is a non-provisional application, which claims the benefit of U.S. Provisional Application No. 63/700,589, filed on Sep. 27, 2024, and 63/609,682, filed on Dec. 13, 2023. These applications are herein incorporated by reference in their entirety.

### BACKGROUND

Conventional transactions systems can process a transaction where a sender and a receiver of a value are in different regions (e.g., different countries). In such transactions, value is exchanged from one type to another type to complete the transaction. In such conventional systems, however, in the transaction, a sending entity computer (e.g., operated by a sender's issuer) that holds an account of the sender needs hold a value of a first type and a value of an intermediate type to cover any future transaction settlements. Further, a receiving entity computer that holds an account of the receiver also needs to hold a value of a second type and a value of the intermediate type to cover any future transaction settlements. This is because an intermediate processing network that routes and processes transactions between the sending entity computer and the receiving entity computer can only process values of the intermediate type. Such value type conversions need to take place well before the transaction and the rates for such value type conversions need to be set at a reasonably lengthy time interval (e.g., once per day).

Because of the above constraints, the receiving entity computer, in particular, needs to hold and estimate the value of intermediate type and the value of the second type sufficient to cover any transaction settlements, even though the ultimate values of such transaction settlements is not known beforehand. The requires the use of a significant amount of additional computation resources and data storage.

Further, because the rates of conversion are set on only change after relatively long periods of time, different rates cannot be applied to different types of transactions with a set time period. This limits the flexibility of these types of transactions.

Embodiments of the invention address these and other problems, individually and collectively.

### SUMMARY

One embodiment includes a method comprising: receiving, by an exchange system from an exchange rate computer, a rate for exchange between a first value type and a second value type; providing, by the exchange system to a clearing and settlement system, the rate or a derivative thereof; receiving, by the exchange system, a trade sum from the clearing and settlement system, wherein the trade sum corresponds to an expected settlement amount for a plurality of transactions in which receivers in the transactions receive values of the second value type, wherein at least some (e.g., all) of the transactions utilize the rate or the derivative thereof; and transmitting, by the exchange system to a correspondent entity computer, an exchange request to exchange an amount of value from the first value type to the second value type, the amount of value based on the trade sum, wherein the clearing and settlement system initiates a transfer message to the correspondent entity computer to transfer the amount of value of the second value type to one or more receiving entity computers associated with one or more receivers.

Another embodiment of the invention includes an exchange system comprising: a processor; and a non-transitory computer readable medium comprising code, executable by the processor for performing operations comprising: receiving, from an exchange rate computer, a rate for exchange between a first value type and a second value type; providing, to a clearing and settlement system, the rate or a derivative thereof;

receiving a trade sum from the clearing and settlement system, wherein the trade sum corresponds to an expected settlement amount for a plurality of transactions in which receivers in the transactions receive values of the second value type, wherein at least some of the transactions utilize the rate or the derivative thereof; and transmitting, to a correspondent entity computer, an exchange request to exchange an amount of value from the first value type to the second value type, the amount of value based on the trade sum, wherein the clearing and settlement system initiates a transfer message to the correspondent entity computer to transfer the amount of value of the second value type to one or more receiving entity computers associated with one or more receivers.

Another embodiment of the invention comprises a processing network comprising: an exchange system comprising a first processor; and a first non-transitory computer readable medium comprising code, executable by the first processor for performing operations comprising: receiving, from an exchange rate computer, a rate for exchange between a first value type and a second value type; providing, to a clearing and settlement system, the rate or a derivative thereof; receiving a trade sum from the clearing and settlement system, wherein the trade sum corresponds to an expected settlement amount for a plurality of transactions in which receivers in the transactions receive values of the second value type, wherein at least some of the transactions utilize the rate or the derivative thereof; and transmitting, to a correspondent entity computer, an exchange request to exchange an amount of value from the first value type to the second value type, the amount of value based on the trade sum, wherein the clearing and settlement system initiates a transfer message to the correspondent entity computer to transfer the amount of value of the second value type to one or more receiving entity computers associated with one or more receivers; and the clearing and settlement system in communication with the exchange system.

These and other embodiments are described in further detail below.

### BRIEF DESCRIPTION OF THE DRAWINGS

FIG. 1 shows a block diagram and a data flow illustrating an exemplary transaction process.

FIG. 2 shows a block diagram and a data flow illustrating a settlement process that is part of the transaction process described with respect to FIG. 1.

FIG. 3 shows a block diagram of an authorization processing computer according to an embodiment.

FIG. 4 shows a block diagram of a clearing and settlement system according to an embodiment.

FIG. 5 shows a block diagram of an exchange system according to an embodiment.

### DETAILED DESCRIPTION

Prior to discussing embodiments of the disclosure, some terms can be described in further detail.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “mobile communication device” may comprise any suitable electronic device that may be transported and operated by a user, which may also optionally provide remote communication capabilities to a network. Examples of remote communication capabilities include using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile communication device may comprise any suitable hardware and software for performing such functions, and may also include multiple devices or components (e.g., when a device has remote access to a network by tethering to another device—i.e., using the other device as a modem—both devices taken together may be considered a single mobile communication device).

A “user” may include an individual. In some embodiments, a user may be associated with one or more personal accounts and/or user devices.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with

substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “transaction message” can be a message that is used to conduct a transaction such as a payment transaction. Examples of transaction messages include authorization request messages, authorization response messages, push transfer messages (e.g., OCT or original credit transaction messages), pull transfer messages (AFT or account funding transaction messages), etc.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of mobile communication devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile communication device can function as a payment device (e.g., a mobile communication device can store and be able to transmit payment credentials for a transaction).

A “value type” can be a specific find of value. Examples of value types can be currencies such as the U.S. dollar, Vietnamese dong, the Euro, Sri Lankan rupees, etc.

Most systems that process transactions in which a user uses a first value type (e.g., a first currency) to transfer value to another user that receives the value in a second value type (e.g., a second type of currency) use a two way settlement process. A receiving entity such as an acquirer (in a pull transaction) or an issuer (in a push transaction) holds both a value of a second value type (e.g., a destination currency such as Vietnamese Dong) and a value of an intermediate type (e.g., a widely used currency such as U.S. dollars). This method of foreign exchange requires that the receiving entity hold large amounts of the second value type and the intermediate value type. This is problematic, since there are there are over 180 currency types, and some currencies such as “exotic currencies” are not widely used. Examples of currencies that are not widely used (relatively to widely used currencies such as the U.S. dollar) include the Kuwait dinar, the Columbian peso, and the Vietnamese dong. Holding large amounts of these exotic currencies when the amounts of settlements are not known beforehand is burdensome and uses additional computational resources and capital.

Embodiments of the invention provide for improved foreign exchange settlement systems and methods that would allow a receiving entity (such as an acquirer or issuer) to settle in foreign currencies that it does not necessarily hold in large amounts. This new one-way settlement configuration also allows a sender user to transfer money to a receiver user from an originating currency to a destination currency without requiring the receiving entity holding the account of the receiver (or a correspondent entity associated with the receiving entity) to possess large amounts of the intermediate value (e.g., an intermediate currency such as US dollars) type or the second value type (e.g., a destination currency such as Vietnamese dong). This is beneficial to both the sender user, the receiver user, and the receiving entity. The receiving entity does not need to maintain large amounts of value types for unknown settlement amounts. The sender user, the receive user, and the receiving entity benefit, since embodiments of the invention allow for the settlement in a larger number of value types (e.g., exotic currencies like Vietnamese dong, Sri Lankan rupees, etc.).

Also, embodiments of the invention provide for the flexibility to offer different exchange rates for a transaction based on its features. Such features may include the identity of the user, the transaction amount, the difficulty of value exchange, etc. Embodiments of the invention can stamp or tag each transaction with service tags that identify various characteristics of the transaction. These tags will allow a processing network to determine whether a particular transaction is eligible for a unique exchange rate.

Some embodiments of the invention can be configured to release trade sums for transactions of applicable exchange rates multiple times a day. Current exchange rate systems push their total trade sums once a day, thereby exposing various parties to risks. By creating a system that pushes trade sums multiple times a day, the parties to the transactions and the settling entities are reducing risks and data storage requirements as transactions are processed more frequently with rates that are more applicable to the features of the transactions.

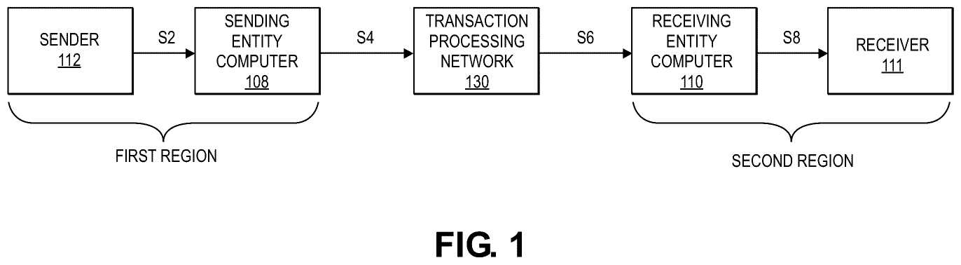

FIG. 1 shows a diagram and an overlaid flow diagram illustrating a transaction conducted between a sender 112 and a receiver 111. The sender can be in a first region that operates using a first type of value and the receiver 111 can be in a second region that operates using a second type of value. As an example, the first region can be a first country such as the United States, while the second region can be a second country such as Vietnam. The first type of value may be U.S. dollars, while the second type of value may be Vietnamese dong.

The sender 112 can have an account managed by a sending entity computer 108, which may also be in the first region. The sending entity computer 108 can be operated by a sending entity such as a sending entity financial institution (e.g., a sender bank or a sender issuer). The receiver 111 can have an account managed by the receiving entity computer 110, which may also be in the second region. The receiving entity computer 110 can be operated by a receiving entity such as a receiving entity financial institution (e.g., a receiver bank, a receiver issuer, or a receiver acquirer).

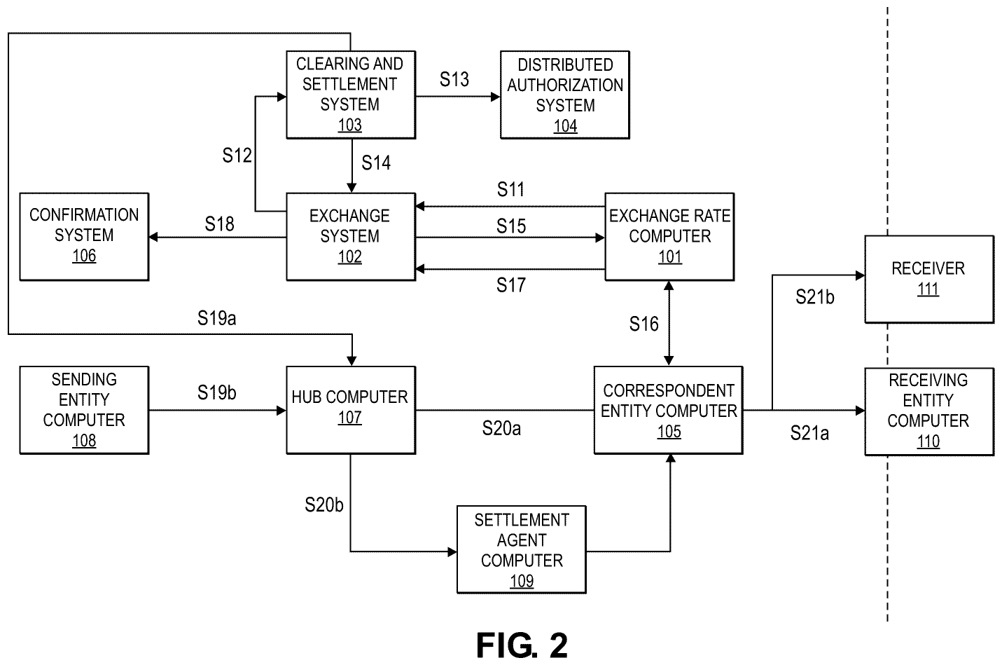

The transaction processing network 130 can process transaction messages passing between the sending entity computer 108 and the receiving entity computer 110. Components of the transaction processing network 130 can include an distributed authorization system (see 104 in FIG. 2) and a clearing and settlement system (see 103 in FIG. 2). The distributed authorization system can be composed of many interconnected authorization processing computers that are geographically separated from each other. They can be programmed in a similar manner so that transactions that are conducted close to the individual authorization processing computers are processed more quickly.

An exemplary transaction processing network may include a payment processing network such as VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base Il system which performs clearing and settlement services. Furthermore, the payment processing network may include a server computer and may use any suitable wired or wireless telecommunications network, including the Internet.

Messages between at least the devices of the system in FIG. 1 (and in FIG. 2) can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

One exemplary type of transaction that can be conducted using the system in FIG. 1 is a push payment transaction. In a push payment transaction, the sender 112 can operate a sender user device (not shown) such as a mobile phone or laptop computer to contact the sending entity computer 108.

In step S2, the sender 112 can use the sender user device to send a message to the sending entity computer 108 to transfer an amount of value of the first type to the receiver 111, who resides in the second region. The receiver 111 may wish to receive the amount of value in the second type rather than the first type. The message may include at least the amount of the value and a credential (e.g., an account number such as a primary account number) of an account of the receiver 111 managed by the receiving entity computer 110. The message may also include a time period in which the amount of value is to be delivered by the receiver 111.

In step S4, the sending entity computer 108 can generate a transaction message such as a push transfer message comprising the amount of the value of the first type and the credential of the receiver 111, and can transmit it to the transaction processing network 130. The push transfer message may also comprise a transaction identifier and a transaction type indicator. An example of a push transfer message may be an OCT (Original Credit Transaction) message. When used in the context of money transfer from a sender user to a receiver user, the OCT is the transaction used to deliver funds to the receiver account. A special indicator identifies an OCT to a downstream authorizing entity computer associated with the receiver user. It is sometimes separate from, and takes place after, the AFT or an account funding transaction message. This timing is to ensure that the value for the interaction is secured before value is sent to the recipient.

In step S6, distributed authorization system of the transaction processing network 130, can determine, using the credential, that the receiving entity computer 110 and the receiver 111 are located in the second region. In some cases, the credential may be a primary account number of PAN. The first six digits of the PAN can be an identifier for the sending entity operating the sending entity computer 110. By identifying the sending entity computer 108, the transaction processing network 130 can determine that the receiver 111 and the receiving entity are located in the second region.

After determining that an exchange from the first type of value to the second type of value is needed to conduct the transaction, the transaction processing network 130 can determine a rate for the transaction. The rate may be determined based on a current market exchange rate for converting the value from the first type to the second type. The rate can also be determined using a number of attributes associated with the transaction. Such attributes can include a transaction amount, the identity of the sender 112, sending entity, the receiving entity, and/or the receiver 111. Once the rate is determined, the rate may may be stored in a database in the transaction processing network along with the details of the transaction. The rate and the transaction details can be used in the final transfer of value to the receiver 111. This will be described in further below with respect to FIG. 2.

In some embodiments, the distributed authorization system of the transaction processing network 130 modifies the authorization request messages with the rate or the derivative thereof, and transmits the modified authorization request messages to receiving entity computers. For example, the distributed authorization system of the transaction processing network 130 may further modify the push transfer message to include the determined exchange rate or derivative thereof, and also an amount of value of the second type which was converted from the value of the first type using the determined exchange rate.

In step S6, the transaction processing network 130 can then transmit the push transfer message to the receiving entity computer 110. Upon receiving the push transfer message, the receiving entity computer 110 can immediately credit the account of the receiver 111 in the value of the second type. In some cases, the receiving entity computer 110 can provide the credit, even though actual funds for the transaction have not yet been received.

In step S8, the receiving entity computer 110 can notify the receiver 111 that the amount of value of the second type for the transaction has been received, and the receiver 111 has access to it.

At a later time, actual funds of the first value type can be transferred from the sender account managed by the sending entity computer 108 and received by a receiver account managed by the receiving entity computer 110 as funds of the second type. This is described below with respect to FIG. 2.

Note that the push transaction process in FIG. 1 is one type of transaction. Other types of transactions can be performed using embodiments of the invention are “pull” transactions where funds are pulled from a sender account to an issuer to a receiver account at an acquirer. A typical use of the pull transaction occurs when making a purchase during international travel, when a user is making a purchase outside of his or her home country. A pull transactions can involve the transmission of an authorization request message comprising an amount from a resource provider computer (e.g., a merchant computer) to an authorizing entity computer (e.g., an issuer computer) via a transport computer (e.g., an acquirer computer) and a processing network computer. The authorizing entity computer then generates and transmits an authorization response message to the resource provider computer via the processing network computer and the transport computer.

FIG. 2 shows a block diagram a system and a data flow according to another embodiment. The system includes a clearing and settlement system 103 in communication with a distributed authorization system 104. An exchange system 102 is in communication with the clearing and settlement system 103 and a confirmation system 106. The clearing and settlement system 103 is in communication with a hub computer 107. The hub computer 107 is in communication with the sending entity computer 108, a correspondent entity computer 105, and a settlement agent computer 109. The correspondent entity computer 105 is in communication with the receiving entity computer 110 and the receiver 111.

The exchange rate computer 101 can be programmed to determine rates for exchanges of value from one type to another type. The rates can be currency exchange rates and can be obtained in real time from currency exchanges.

The exchange system 102 can include one or more computers programmed to initiate or execute trades of one value type to another value type. The one or more computers may also be programmed to send confirmation messages and create different types of rates or rate products based on rates received from the exchange rate computer 101.

The distributed authorization system 104 can include one or more computers programmed to perform authorization processing. Authorization processing can include routing and/or approving or declining authorization request and response messages, as well as transaction request messages. The distributed authorization system 104 can include many different interconnected computers that may be present in different regions. The distributed authorization system 104 can be programmed to identify transactions that may be appropriate for a particular rate or derivative thereof, and pass those identified transactions to the clearing and settlement system 103.

The clearing and settlement system 103 can include one or more computers programmed to perform clearing and settlement processing. It can determine a trade sum for groups of transactions associated with a particular rate or derivative thereof.

The correspondent entity computer 105 can be programmed to perform exchanges (e.g., trades) of amounts of value from one type to another type. The correspondent entity computer 105 can also receive payment instructions, receive funds, and execute any payment instructions.

The confirmation system 106 can be programmed to provide confirmation to any relevant parties to a transaction.

The hub computer 107 can be programmed to receive payment instructions from a sending entity computer 108 or receiving entity computer 110 for specific transactions. The hub computer 107 can also be programmed to receive payment instructions associated with a trade sum amount. Such payment instructions may be received from the clearing and settlement system 103.

The settlement agent computer 109 can be an intermediary that can provide funds to a correspondent entity in response to settlement of a plurality of transactions.

The sending entity computer 108, the receiving entity computer 110, and the receiver 111, are described above with respect to FIG. 1.

In some embodiments, some components in FIG. 2 can be present in the transaction processing network 130 shown in FIG. 1. For example, in some embodiments, the exchange system 102, the clearing and settlement system 103, the distributed authorization system 104, and the hub computer 107 can be components within the transaction processing network 130. In other embodiments, the transaction processing network 130 can have more or less than these specific components.

FIG. 2 also illustrates a method for exchanging value to settle specific transactions according to an embodiment of the invention.

At step S11, the exchange rate computer 101 sends a trade rate for exchange between a first value type (e.g., a first currency) and a second value type (e.g., a second currency) to the exchange system 102. The trade rate or “rate” can be one of many trade rates (e.g., a currency exchange rate) for exchanges between different value types in a trade rate feed. After receiving one or more trade rates from the exchange rate computer 101, in some embodiments, the exchange system 102 can create spreads and/or foreign exchange products for the one or more rates. A foreign exchange product may be based on at least the one or more exchange rates and a user and/or transaction profile. The spreads or the rate products can be derivatives of the one or more rates.

At step S12, the one or more rates, or derivatives of the rates, can then be provided (e.g., sent or transmitted) to the clearing and settlement system 103. Rates derivatives thereof (e.g., rate products and rate spreads) for different value type conversions (e.g., rates for conversions from US dollars to Vietnamese dong, Euros to Sri Lankan rupees, etc.) to can be pushed to the clearing and settlement system 103 multiple times per hour, or multiple times per day. These rates or derivatives thereof can be in the form of rate files, which are validated and time stamped by the clearing and settlement system 103.

At step S13, a rate file with the one or more rates or rate products may be sent to the distributed authorization system 104. The distributed authorization system 104 can use the rate file to determine applicable rates for the transactions that it is routing and evaluating. If a transaction is eligible for a particular rate in the rate file, then the transaction would be stamped or tagged indicating its eligibility and may also be stamped or tagged with a rate feed ID and a rate product, which can be derived from the rate. The transaction and other transactions with the same rate feed ID and rate product can be passed to the clearing and settlement system 103. Other transactions tagged with other rate feed IDS and rate products can also be provided to the clearing and settlement system 103. The transactions can be identified using transaction identifiers.

In another embodiment, the distributed authorization system 104 may evaluate various features to determine eligibility of a given transaction for a particular rate. These features may include the particular user and whether they are a preferred client. If the transaction is eligible for the preferential rate, then the preferential rate would be applied to that individual transaction.

At step S14, the clearing and settlement system determines a trade sum for transactions that are eligible for the determined rate. In embodiments of the invention, the trade sum can correspond to an expected settlement amount for a plurality of transactions in which receivers in the transactions receive values of the second value type. It can be a summary of the aggregate settlement value owed by the settling entity (i.e., the entity such as Visa International Service Association that operates the clearing and settlement system 103) for settling a given set of transactions. For example, if the clearing and settlement system 103 will eventually have to settle a specific group of authorized transactions that total about 24,257,537,423 Vietnamese dong, then the trade sum of 24,257,537,423 Vietnamese dong (or an equivalent amount of another value type such as 1M U.S. dollars) may be sent to the exchange system 102. This is done to ensure that the downstream correspondent entity has sufficient liquidity to settle the group of transactions. Note that, in some embodiments, the trade sum can be an aggregate of all of the transaction amounts for transactions where correspondent entity computer 105 needs to obtain funds of the second value type for different receiving entities for a given period of time. The trade sum can include transaction amounts for transactions that were tagged with different currency conversion rates, since the trade sum is an indication of how much of the second value type that correspondent entity computer 105 needs to obtain to settle obligations for different groups of transactions.

The clearing and settlement system 103 can also compute the values, fees, charges, etc. associated with the transactions and can send the trade sum to the exchange system 102 and the exchange system 102 receives the same. The clearing and settlement system 103 can schedule the trade sums of many different value types for many different transaction groups for transmission to the exchange system 102.

At step S15, the exchange system 102 sends a trade request associated with the received trade sum to the exchange rate computer 101, where received trade requests can be automatically executed. The exchange request can be a request to exchange an amount of value from the first value type to the second value type, the amount of value based on the trade sum received in step S14.

At step S16, the correspondent entity computer 105 receives a trade request from the exchange rate computer 101. After receiving the trade request, the correspondent entity computer 105 can conduct the trade. The correspondent entity computer 105 can be operated by a bank in a destination country associated with the currency of the recipient/payee. The correspondent entity computer 105 can have accounts for the settling entity with different currencies. The trade request can cause the correspondent entity computer 105 to trade a particular amount of currency to eventually settle obligations. For example, the correspondent entity computer 105 can maintain accounts in U.S. dollars, Euros, and Vietnamese Dong for the settling entity. If the trade request is to convert $1M U.S. dollars to Vietnamese Dong, then the correspondent bank can trade $1M U.S. dollars in the settling entity's account, and exchange it for 24,257,537,423 Vietnamese dong. The settling' entity's U.S. dollar and Vietnamese dong accounts will be debited and credited accordingly. Note that in some embodiments, these accounts may be virtual, in that there are actual funds are not in the virtual accounts. They can be used to keep track of the credits and debits of the different value types. At this step, the trade sum money in the receiver's currency is recorded by the correspondent entity computer 105 until a message from the settling entity notifies the correspondent entity computer 105 to settle the transaction (which occurs at steps S19a and S19b below).

At step S17, the exchange rate computer 101 transmits a post-trade message to the exchange system 102 to notify the exchange system 102 that a trade has occurred.

At step S18, the exchange system 102 sends a deal confirmation message to the confirmation system 106.

Once the exchange has taken place, payment instructions can be received by the hub computer 107 to complete the settlement process.

The clearing and settlement system 103 can initiate a transfer message to the correspondent entity computer 105 to transfer the amount of value of the second value type to one or more receiving entity computers associated with one or more receivers.

In step S19a, the clearing and settlement system 103 can transmit the transfer message to a hub computer 107, which transmits the transfer message to the correspondent entity computer 105. For example, the clearing and settlement system 103 can send payment instructions to the hub computer 107, which can forward them to the correspondent entity computer 105.

Alternatively or additionally, at step S19b, the sending entity computer 108 sends a receiver transfer instruction message from to the hub computer 107 comprising details (e.g., transaction IDs, account numbers, amounts, etc.) relating to a transfer of value of the second type (e.g., Vietnamese dong) to a receiver account managed by the receiving entity computer 110 using a value of the first value type (e.g., U.S. dollars) from an account of a sender managed by the sender entity computer. For example, in step S19b, the sending entity computer 108 sends payment instructions regarding the receiver of the payment to the hub computer 107.

At step S20a, the hub computer 107 sends a message instructing the correspondent entity computer 105 to send the destination currency to the receiving entity associated with the receiving entity computer 108 (step 21a). Alternatively, or additionally, the hub computer 107 sends a message instructing the correspondent entity computer 105 to send the destination currency to the receiver 111 (step 21b). In step S21a, the receiving entity computer 110 can use the payment instructions from step 20a credit the appropriate receiver account(s).

At step S20b, which can occur in conjunction with step S20a, the hub computer transmits to the settlement agent computer 109, a second transfer message. The second transfer message instructs the settlement agent computer 109 to transfer a settlement value of the first value type to the correspondent entity computer 105. For example, the hub computer 107 sends a message to the settlement agent computer 109 to pay the correspondent entity associated with the correspondent entity computer 105 for the value associated with the trade sum. For example, the hub computer 107 can instruct the settlement agent computer 109 to pay $1M U.S. Dollars to the correspondent entity associated with the correspondent entity computer 105 consistent with the trade in step S16.

In some embodiments, as briefly discussed above, the system according to embodiments of the invention would have the ability to configure different rates for sending entities or receiving entities (e.g., sending banks and receiving banks). This means that multiple rates can be active on the network at a given time. Different transactions may receive different rates based on different transaction attributes.

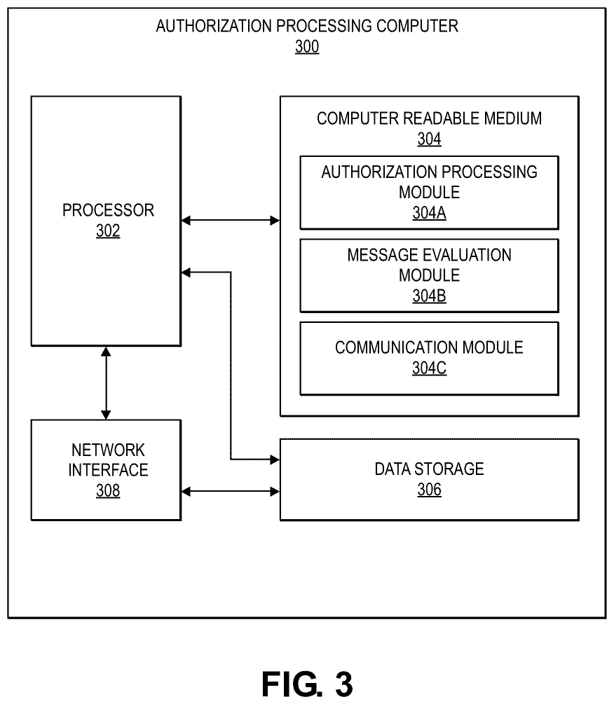

FIG. 3 shows a block diagram of an authorization processing computer according to an embodiment.

FIG. 3 shows a block diagram of an authorization processing computer 300 according to an embodiment. The authorization processing computer 300 may comprise a processor 302, which may be coupled to a computer readable medium 304, a data storage 306, and a network interface 308.

The computer readable medium 304 may comprise a number of software modules including an authorization processing module 304A, a message evaluation module 304B, and a communication module 304C.

The authorization processing module 304A may comprise code that can cause the processor 302 to evaluate authorization request messages for transactions and determine if the transactions should be authorized. The authorization processing module 304A may also include code for routing or modifying authorization request and response messages as they pass between various parties such as authorizing entity computers (e.g., issuer computers) and transport computers (e.g., acquirer computers).

The message evaluation module 304B may include code for causing the processor to evaluate authorization request messages to determine if any attributes associated therewith are appropriate for rates conversion of from one value type to another value type.

The communication module 604C may comprise code that causes the processor 602 to generate messages, forward messages, reformat messages, and/or otherwise communicate with other entities.

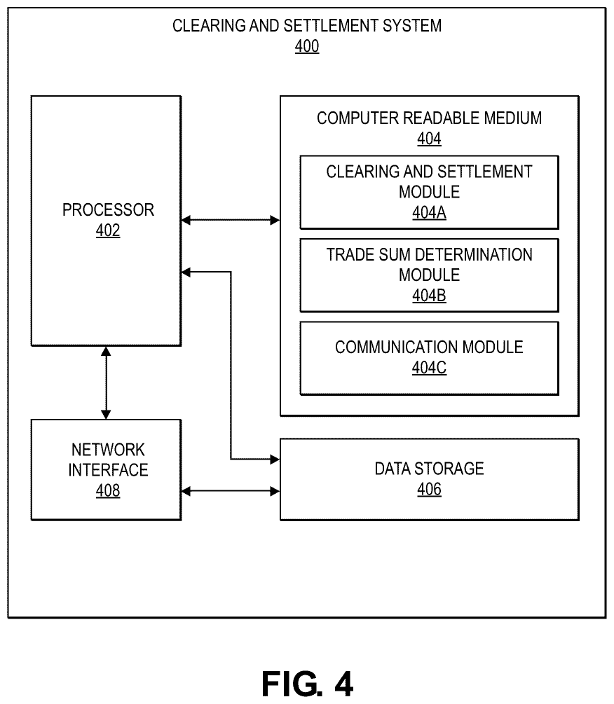

FIG. 4 shows a block diagram of a clearing and settlement system according to an embodiment. The clearing and settlement system may comprise a processor 402, which may be coupled to a computer readable medium 404, data storage 406, and a network interface 408.

The computer readable medium 404 may comprise a number of software modules including a clearing and settlement module 404A, a trade sum determination module 404B, and a communication module 404C.

The clearing and settlement module 404A may comprise code that can cause the processor 402 to route clearing messages and perform settlement processing.

The trade sum determination module 404B may include code for causing the processor to determine trade sums for transactions associated with particular conversion rates for rates conversion of from one value type to another value type.

The communication module 404C may comprise code that causes the processor 402 to generate messages, forward messages, reformat messages, and/or otherwise communicate with other entities.

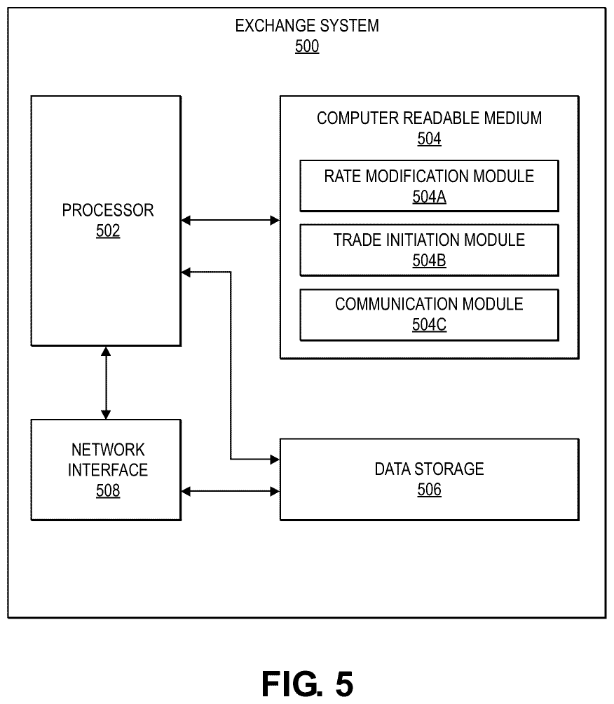

FIG. 5 shows a block diagram of an exchange system 500 according to an embodiment. The exchange system 500 may comprise a processor 502, which may be coupled to a computer readable medium 504, data storage 506, and a network interface 508.

The computer readable medium 504 may comprise a number of software modules including a rate modification module 504A, a trade initiation module 504B, and a communication module 504C.

The rate modification module 504A may comprise code for taking one or more rates and creating derivatives of those rates (e.g., rate spreads or rate products).

The trade initiation module 504B may include code for causing the processor to initiate one or more trades of value of one type to another type.

The communication module 504C may comprise code that causes the processor 602 to generate messages, forward messages, reformat messages, and/or otherwise communicate with other entities.

The computer readable medium 504 may comprise code, executable by the processor 502 to perform operations comprising: receiving, from the exchange rate computer, a rate for exchange between a first value type and a second value type; providing, to a clearing and settlement system, the rate or a derivative thereof; receiving a trade sum from the clearing and settlement system, wherein the trade sum corresponds to an expected settlement amount for a plurality of transactions in which receivers in the transactions receive values of the second value type, wherein at least some of the transactions utilize the rate or the derivative thereof; and transmitting, to a correspondent entity computer, an exchange request to exchange an amount of value from the first value type to the second value type, the amount of value based on the trade sum, wherein the clearing and settlement system initiates a transfer message to the correspondent entity computer to transfer the amount of value of the second value type to one or more receiving entity computers associated with one or more receivers.

Embodiments of the invention provide for a number of advantages. For example, embodiments of the invention provide conversions of value from one type to another for specific transactions with greater frequency and speed as compared to conventional transactions. This can save on data processing and the need to store large amounts of value types (currencies) by an entity such as a correspondent entity computer.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by an exchange system from an exchange rate computer, a rate for exchange between a first value type and a second value type;
providing, by the exchange system to a clearing and settlement system, the rate or a derivative thereof;
receiving, by the exchange system, a trade sum from the clearing and settlement system, wherein the trade sum corresponds to an expected settlement amount for a plurality of transactions in which receivers in the transactions receive values of the second value type, wherein at least some of the transactions utilize the rate or the derivative thereof; and
transmitting, by the exchange system to a correspondent entity computer, an exchange request to exchange an amount of value from the first value type to the second value type, the amount of value based on the trade sum,
wherein the clearing and settlement system initiates a transfer message to the correspondent entity computer to transfer the amount of value of the second value type to one or more receiving entity computers associated with one or more receivers.

2. The method of claim 1, wherein after the exchange request is submitted, the method further comprises:
transmitting, by the clearing and settlement system, the transfer message to a hub computer, which transmits the transfer message to the correspondent entity computer.

3. The method of claim 2, wherein the transfer message is a first transfer message, and the method further comprises:
transmitting, by the hub computer to a settlement agent computer, a second transfer message, wherein the second transfer message instructs the settlement agent computer to transfer a settlement value of the first value type to the correspondent entity computer.

4. The method of claim 1, further comprising:
receiving, by the exchange system, a plurality of rates per day, the rates for exchanges of one type of value to a different type of value.

5. The method of claim 1, wherein the clearing and settlement system receives data relating to the plurality of transactions from a distributed authorization system.

6. The method of claim 5, wherein the distributed authorization system receives transaction messages for the plurality of transactions and modifies the transaction messages with the rate or the derivative thereof, and transmits the modified transaction messages to receiving entity computers.

7. The method of claim 1, wherein after the exchange request is submitted, the method further comprises:
transmitting, by the clearing and settlement system, the transfer message to a hub computer, which transmits the transfer message to the correspondent entity computer, and wherein the hub computer receives a receiver transfer instruction message from a sender entity computer, the receiver transfer instruction message comprising details relating to a transfer of value of the second value type to a receiver account managed by a receiver entity computer using a value of the first value type from an account of a sender managed by the sender entity computer.

8. The method of claim 1, wherein a hub computer receives a receiver transfer instruction message from a sender entity computer, the receiver transfer instruction message comprising details relating to a transfer of value of the second value type to a receiver account managed by a receiver entity computer using a value of the first value type from an account of a sender managed by the sender entity computer, and wherein after the exchange request is submitted, the method further comprises:
transmitting, by the clearing and settlement system, the transfer message to the hub computer, which transmits the transfer message to the correspondent entity computer, the transfer message including the details relating to the transfer of value of the second value type to the receiver account.

9. The method of claim 1, wherein the clearing and settlement system receives data relating to the plurality of transactions from a distributed authorization system, and wherein the distributed authorization system receives transaction messages for the plurality of transactions and modifies the transaction messages with different rates, and transmits the modified transaction messages to receiving entity computers.

10. The method of claim 9, wherein the different rates are determined based on attributes of the transaction messages.

11. An exchange system comprising:
a processor; and
a non-transitory computer readable medium comprising code, executable by the processor for performing operations comprising:
receiving, from an exchange rate computer, a rate for exchange between a first value type and a second value type;
providing, to a clearing and settlement system, the rate or a derivative thereof;
receiving a trade sum from the clearing and settlement system, wherein the trade sum corresponds to an expected settlement amount for a plurality of transactions in which receivers in the transactions receive values of the second value type, wherein at least some of the transactions utilize the rate or the derivative thereof; and
transmitting, to a correspondent entity computer, an exchange request to exchange an amount of value from the first value type to the second value type, the amount of value based on the trade sum,
wherein the clearing and settlement system initiates a transfer message to the correspondent entity computer to transfer the amount of value of the second value type to one or more receiving entity computers associated with one or more receivers.

12. The exchange system of claim 11, wherein the operations further comprise:
receiving a plurality of rates per day, the rates for exchanges of one type of value to a different type of value.

13. The exchange system of claim 11, wherein the operations further comprise:
transmitting, to the corresponding entity computer, a plurality of exchange rate requests to exchange value of more than twenty different value types per day.

14. The exchange system claim 11, wherein the operations further comprise:
receiving, from the exchange rate computer, a plurality of rates for exchanges between more than twenty types of value within a day.

15. A processing network comprising:
an exchange system comprising
a first processor; and
a first non-transitory computer readable medium comprising code, executable by the first processor for performing operations comprising:
receiving, from an exchange rate computer, a rate for exchange between a first value type and a second value type;
providing, to a clearing and settlement system, the rate or a derivative thereof;
receiving a trade sum from the clearing and settlement system, wherein the trade sum corresponds to an expected settlement amount for a plurality of transactions in which receivers in the transactions receive values of the second value type, wherein at least some of the transactions utilize the rate or the derivative thereof; and
transmitting, to a correspondent entity computer, an exchange request to exchange an amount of value from the first value type to the second value type, the amount of value based on the trade sum,
wherein the clearing and settlement system initiates a transfer message to the correspondent entity computer to transfer the amount of value of the second value type to one or more receiving entity computers associated with one or more receivers; and
the clearing and settlement system in communication with the exchange system.

16. The processing network of claim 15, further comprising:
the exchange rate computer.

17. The processing network of claim 15, wherein the clearing and settlement system comprises a second processor and a second non-transitory computer readable medium comprising code, executable by the second processor to perform operations comprising:
transmitting, by the clearing and settlement system, the transfer message to a hub computer, which transmits the transfer message to the correspondent entity computer.

18. The processing network of claim 17, further comprising the hub computer.

19. The processing network of claim 18, wherein the hub computer comprises a third processor and a third computer readable medium comprising code, executable by the third processor for performing operations comprising:
receiving a receiver transfer instruction message from a sender entity computer, the receiver transfer instruction message comprising details relating to a transfer of value of the second value type to a receiver account managed by a receiving entity computer using a value of the first value type from an account of a sender managed by the sender entity computer.

20. The processing network of claim 15, wherein the clearing and settlement system is programmed to receive data relating to the plurality of transactions from a distributed authorization system.
